(19) United States
(12) Patent Application Publication
(10) Pub. No.: US 2021/0337264 A1
(43) Pub. Date: Oct. 28, 2021

(54) IMAGE PROCESSING METHOD, VIDEO PLAYBACK METHOD AND APPARATUSES THEREOF

(71) Applicant: KAI INC., Yuseong-Gu Daejeon (KR)

(72) Inventors: Seung Hwa JEONG, Seo-Gu Daejeon (KR); Jung Jin LEE, Seo-Gu Daejeon (KR); Sang Woo LEE, Sejong-Si (KR); Kye Hyun KIM, Gwangmyeong-Si Gyeonggi-do (KR); Seong Kyu HAN, Seo-Gu Daejeon (KR); Ju Yeon LEE, Seo-Gu Daejeon (KR); Young Hui KIM, Gangnam-Gu Seoul (KR)

(73) Assignee: KAI INC., Yuseong-Gu Daejeon (KR)

(21) Appl. No.: 16/627,597

(22) PCT Filed: Sep. 18, 2019
(86) PCT No.: PCT/KR2019/012057

§ 371 Date: Dec. 30, 2019

(30) Foreign Application Priority Data
Nov. 28, 2018 (KR) 10-2018-0149921

(51) Int. Cl. H04N 21/431; H04N 21/4402; H04N 21/4728

(52) U.S. Cl. CPC H04N 21/4318; H04N 21/4728; H04N 21/4402

(57) ABSTRACT

A method of processing an image receives a first video including a plurality of frames, obtains importance information indicating importance of at least one region included in the plurality of frames, determines axes of a grid for at least one region of the first video based on the importance information, generates a second video by encoding the first video based on the axes of the grid, and outputs the second video and information about the axes of the grid.

### TECHNICAL FIELD

The following embodiments relate to a method of processing an image, a method of playing an image, and apparatuses thereof.

### BACKGROUND ART

A user viewpoint-based method and a content-based method may be used to provide streaming. The user viewpoint-based method is a method of encoding and streaming the region viewed by a user, that is, only the region corresponding to the user's viewpoint. In the user viewpoint-based method, when the user changes the viewpoint suddenly, the latency of the image quality change may occur. Furthermore, in the user viewpoint-based method, when a piece of content is multi-encoded differently for each viewpoint, the capacity and computational overhead of an image may occur.

The content-based method refers to a method of streaming images by optimizing the area of each grid of an image based on the importance of the image. The content-based method may take a lot of time to calculate the importance of the image and to optimize the area of each grid.

### DISCLOSURE OF INVENTION

### Technical Solution

According to an aspect, a method of processing an image includes receiving a first video including a plurality of frames, obtaining importance information indicating importance of at least one region included in the plurality of frames, determining axes of a grid for at least one region of the first video, based on the importance information, generating a second video by encoding the first video based on the axes of the grid, and outputting the second video and information about the axes of the grid.

The determining of the axes of the grid may include determining the axes of the grid such that a resolution of the at least one region is maintained and a resolution of remaining regions other than the at least one region is down-sampled, based on the importance information.

The determining of the axes of the grid may include determining the axes of the grid based on a preset target capacity of an image, by setting at least one of the number of grids for at least one region included in a plurality of frames of the first video and a target resolution of a grid.

The determining of the axes of the grid may include at least one of determining the axes of the grid by determining a source resolution of the first video as a first resolution of a first region corresponding to a target resolution of the grid, determining the axes of the grid such that a resolution of a remaining second region other than the first region is down-sampled to a second resolution lower than the first resolution, and determining the axes of the grid such that a resolution of third regions adjacent to the first region is down-sampled to third resolutions gradually changed from the first resolution to the second resolution.

The second resolution may be determined based on the preset target capacity of the image.

The determining of the axes of the grid may include determining a size of a column included in the grid and a size of a row included in the grid.

The determining of the size of the column and the size of the row may include increasing at least one of the size of the column and the size of the row for a corresponding region as importance of a region, which is indicated by the importance information, is higher than a preset criterion.

The generating of the second video may include dividing the first video into a plurality of regions based on the axes of the grid and sampling information of the first video depending on sizes of the plurality of regions.

The outputting may include visually encoding information about the axes of the grid and combining and outputting the visually encoded information and the second video.

The obtaining of the importance information may include at least one of receiving the importance information set in compliance with at least one region of each frame of the first video, from a producer terminal monitoring the first video and receiving importance information determined in real time in compliance with at least one region of each frame of the first video by a neural network trained in advance.

The first video may include a 360-degree virtual reality streaming content.

The method of processing the image may further include storing the second video and information about the axes of the grid, in cloud storage.

According to another aspect, a method of playing an image includes obtaining an image having a plurality of regions including a plurality of resolutions, obtaining information about axes of a grid separating the plurality of regions, and playing the image based on information about the axes of the grid.

The information about the axes of the grid may include a size of a column included in the grid and a size of a row included in the grid.

The decoding of the image may include extracting information about the axes of the grid corresponding to at least one region of the image, from the image.

The playing of the image may include rendering the plurality of regions based on the image and information about the axes of the grid.

The playing of the image may further include playing at least part of a region corresponding to a current time point of a playback camera among the rendered plurality of regions.

According to another aspect, an apparatus for processing an image includes a communication interface configured to receive a first video including a plurality of frames and a processor. The processor is configured to obtain importance information indicating importance of at least one region included in the plurality of frames, to determine axes of a grid for at least one region of the first video based on the importance information, and to encode the first video based on the axes of the grid to generate a second video. The communication interface outputs the second video and information of the axes of the grid.

According to another aspect, an image playback apparatus includes a communication interface obtaining an image having a plurality of regions including a plurality of resolutions and a processor obtaining information about axes of a grid separating the plurality of regions and playing the image based on information about the axes of the grid.

### BRIEF DESCRIPTION OF THE DRAWINGS

FIG. 1 is a diagram illustrating a method of processing an image according to an embodiment.

FIG. 2 is a flowchart illustrating a method of processing an image according to an embodiment.

FIG. 3 is a diagram illustrating a method of obtaining importance information according to an embodiment.

FIG. 4 is a diagram illustrating a method of generating a second video according to an embodiment.

FIG. 5 is a diagram illustrating a method of playing an image according to an embodiment.

FIG. 6 is a flowchart illustrating a method of playing an image according to an embodiment.

FIG. 7 is a diagram illustrating a configuration of an image processing system according to an embodiment.

FIG. 8 is a block diagram of an image processing apparatus or an image playback apparatus according to an embodiment.

### BEST MODE FOR CARRYING OUT THE INVENTION

Specific structural or functional descriptions disclosed in this specification are exemplified only for the purpose of describing embodiments according to the present disclosure, and the embodiments may be implemented in various different forms, not limiting the embodiments described in this specification.

The terms “first” or “second” are used to describe various elements, but it should be understood that the terms are only used to distinguish one element from other elements. For example, a first element may be termed a second element, and a second element may be termed a first element, without departing from the scope of the present disclosure.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” or the like).

The articles “a,” “an,” and “the” are singular in that they have a single referent, however, the use of the singular form in the present document should not preclude the presence of more than one referent. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

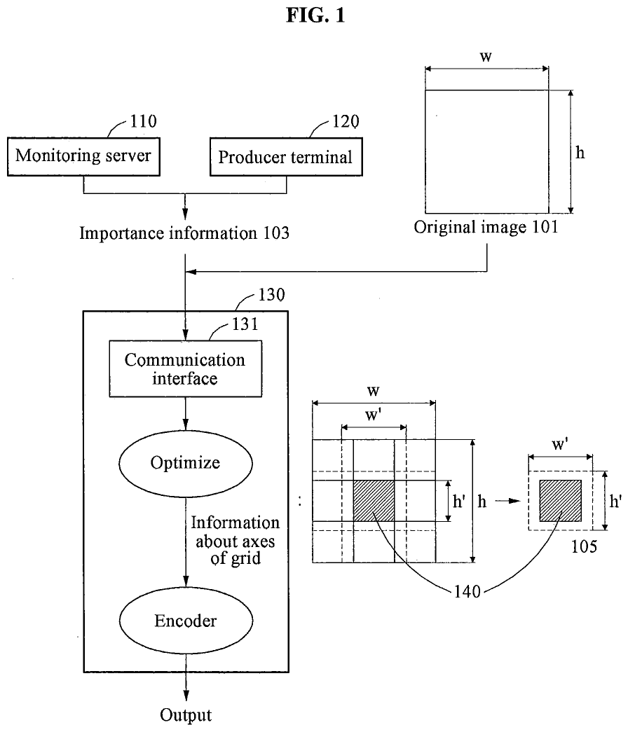

FIG. 1 is a diagram illustrating a method of processing an image according to an embodiment. Referring to FIG. 1, according to an embodiment, an apparatus (hereinafter referred to as an “image processing apparatus” 130) for processing an image may obtain importance information 103 from, for example, a monitoring server 110 or a producer terminal 120. Herein, the importance information may be information indicating the importance of the region(s) included in a plurality of frames of an original image 101. The importance information 103 may be set in compliance with at least one region of each frame of the original image 101. The importance information may be represented in various forms such as masking, heatmap, or the like. For example, the importance information 103 may further include the playback time point of a frame including at least one region among a plurality of frames, the number of vertices included in at least one region, the mask number corresponding to at least one region, or the like in addition to the importance of at least one region included in a plurality of frames of the original image 101.

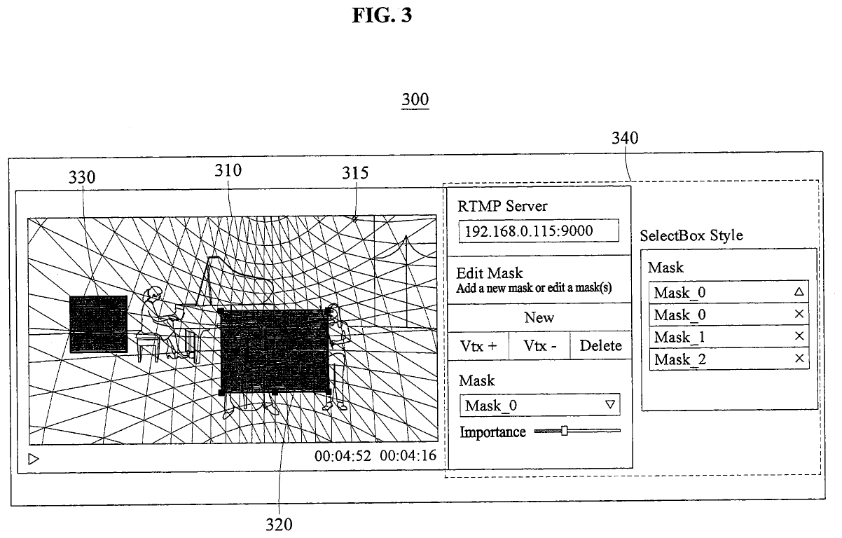

For example, the importance information 103 may be set through the monitoring server 110 monitoring the original image 101 and may be set by the producer terminal 120. As illustrated in FIG. 3 below, for example, a producer may set the importance information 103 about the original image 101 through a monitoring application provided to the producer terminal 120. Alternatively, the monitoring server 110 may automatically set the importance information 103 for the original image 101, using a pre-trained neural network. When the original image 101 is a live image, the monitoring server 110 may generate the importance information 103 in real time. For example, the neural network may be a neural network that has been trained in advance to recognize the region of high importance, that is, an important region, in the original image 101 that many viewers watch, based on a viewer's viewpoint. Alternatively, for example, the neural network may be a neural network that has been trained in advance to recognize the region of high importance, such as performers, performance stages, or the like other than the audience included in the original image 101. For example, the neural network may be a deep neural network including a convolution layer.

The original image 101 may be a 360-degree content image transmitted through various streaming protocols. The streaming protocol may be a protocol used for streaming audio, video, other data, or the like through Internet and may include, for example, real-time messaging protocol (RTMP), HLS, or the like. For example, the original image 101 may be an image having a size of width (w)×height (h). At this time, the width (w) may correspond to the size of the entire columns in the width direction; the height (h) may correspond to the size of the entire rows in the height direction. Hereinafter, for convenience of description, the original image 101 may be referred to as a ‘first video’ or ‘first image’.

The image processing apparatus 130 may receive the original image 101 and the importance information 103 through a communication interface 131. The image processing apparatus 130 may determine the size of at least one region of the original image 101 based on the importance information 103. The image processing apparatus 130 may determine the axes of the grid such that the resolution of the critical region corresponding to a grid 140 is maintained and the resolution of the remaining regions other than the critical region is down-sampled.

For example, the image processing apparatus 130 may optimize the size of at least one region by determining the axes of the grid for at least one region of the original image 101 based on the importance information 103. In the optimization process, the image processing apparatus may generate the grid 140 in each frame. For example, the image processing apparatus 130 may calculate an optimal area value according to the importance of at least one region in units of each row and column of the grid 140, based on the preset target capacity of the image.

The image processing apparatus 130 may generate an image 105 for a live streaming service by encoding the original image 101 based on information about the axes of a grid. At this time, the information about the axes of the grid may include information about the sizes of the columns included in the grid 140 and the sizes of the rows included in the grid 140. For example, the image 105 may be an image having a size of width (w′)×height (h′). Hereinafter, for convenience of description, the image 105 for a streaming service may be referred to as a ‘second video’ or ‘second image. The streaming service may include a streaming service for live broadcasting and a streaming service for VOD playback. Hereinafter, the live streaming service for convenience of description is assumed.

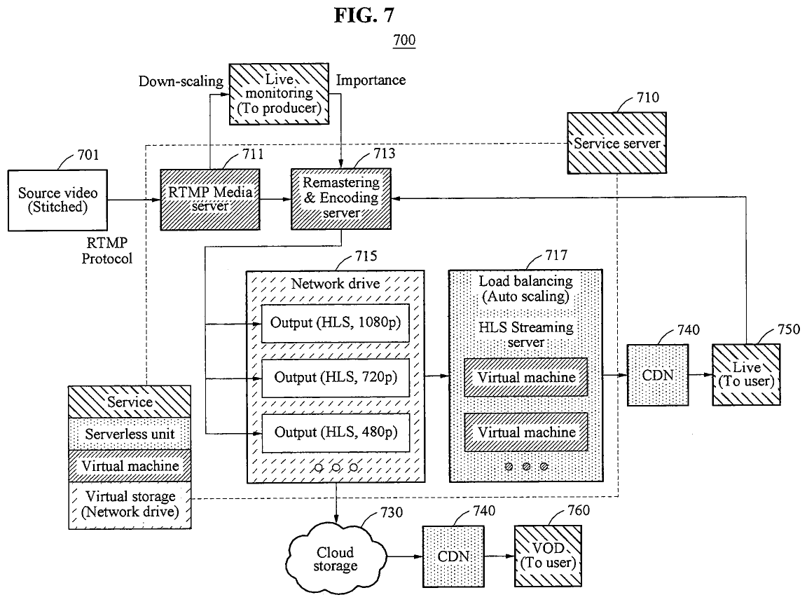

The image processing apparatus 130 may output the image 105 and information about the axes of a grid. At this time, the information about the axes of the grid is color-encoded and may be included in the image 105. For example, the image processing apparatus 130 may be a service server providing a live streaming service (refer to a service server 710 of FIG. 7).

While reducing the time required to determine the area of each grid through the information about the axes of the above-described grid, the image processing apparatus 130 according to an embodiment may reduce the overall capacity of the image content by maintaining the resolution of the critical region and by lowering the resolution of the remaining regions other than the critical region; accordingly, the image processing apparatus 130 according to an embodiment may provide a content-based streaming service in real time.

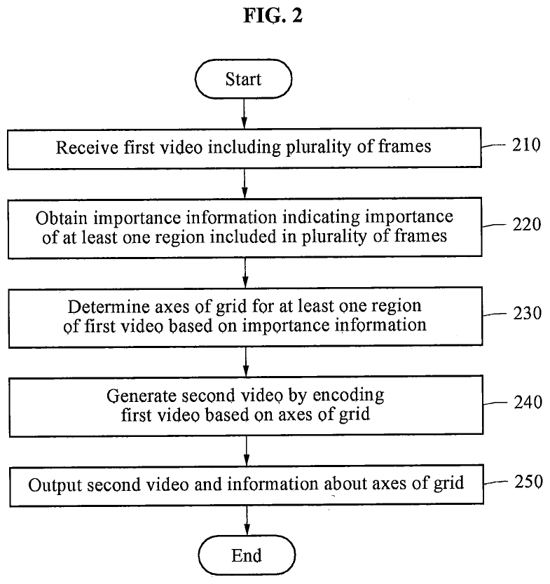

FIG. 2 is a flowchart illustrating a method of processing an image according to an embodiment. Referring to FIG. 2, in operation 210, an apparatus (hereinafter, referred to as an “image processing apparatus”) for processing an image according to an embodiment receives a first video including a plurality of frames. For example, the first video may be a 360-degree image transmitted through a live stream protocol.

In operation 220, the image processing apparatus obtains importance information indicating the importance of at least one region included in a plurality of frames. Herein, for example, the importance of at least one region may be determined based on the image gradient of the pixels of the region corresponding to each of a plurality of frames in the first video, whether an edge is detected in each region, the number of vertices (or feature points) included in each region, and whether an object (e.g., people, animals, cars, or the like) is detected in each region.

For example, when the image gradient of pixels of at least one region in the first video is greater than or equal to a predetermined criterion, the importance of the at least one region may be determined to be high. Alternatively, when the image gradient of pixels of at least one region in the first video is less the predetermined criterion, the importance of the at least one region may be determined to be low.

For example, when at least one region in the first video corresponds to an edge, the importance of the at least one region may be determined to be high. When at least one region in the first video does not correspond to an edge, the importance of the at least one region may be determined to be low. Alternatively, when at least one region in the first video corresponds to an object (e.g., people, things, or the like), the importance of the at least one region may be determined to be high. For example, the importance of at least one region may have a value between 0 and 1 or between 0 and 10.

For example, the image processing apparatus may receive importance information set in compliance with at least one region of each frame of the first video, from a producer terminal monitoring the first video. Alternatively, the image processing apparatus may receive importance information determined in real time in compliance with at least one region of each frame of the first video by the neural network that has been trained in advance. A method in which the image processing apparatus obtains importance information from a producer terminal will be described in detail with reference to FIG. 3.

In operation 230, the image processing apparatus determines the axes of the grid for at least one region of the first video, based on importance information. The image processing apparatus may determine the axes of the grid such that the resolution of at least one region is maintained and the resolution of the remaining regions other than at least one region is down-sampled, based on importance information. The image processing apparatus may determine the size of a column included in a grid and the size of a row included in a grid. For example, as the importance of the region, which is indicated by importance information, is higher than the preset criterion, the image processing apparatus may increase at least one of the size of the column and the size of the row for the corresponding region. Alternatively, as the importance of the region, which is indicated by importance information, is lower than the preset criterion, the image processing apparatus may decrease at least one of the size of the column and the size of the row for the corresponding region.

For example, the image processing apparatus may determine the axes of the grid based on the preset target capacity of the image, by setting at least one of the number of grids for at least one region included in a plurality of frames of the first video and the target resolution of the grid. For example, it is assumed that the target capacity of an image is 720 Mbytes. The image processing apparatus may determine the axes of a grid such that the total capacity of the image according to the number of grid(s) for the critical region, the target resolution of the corresponding grid(s), and the resolution of the remaining regions other than the grid(s) does not exceed 720 Mbytes that is the target capacity.

In operation 230, the image processing apparatus may determine the axes of the grid by determining the source resolution of the first video, in other words, the resolution of the original image as the first resolution of the first region corresponding to the grid. Alternatively, the image processing apparatus may determine the axes of the grid such that the resolution of the remaining second region other than the first region is down-sampled to the second resolution lower than the first resolution. At this time, the second resolution may be determined based on the preset target capacity of the image. For example, the second resolution may be determined based on the remaining capacity other than the capacity due to the first region in the preset target capacity of the image.

Besides, the image processing apparatus may determine the axes of the grid such that the resolution of third regions adjacent to the first region is down-sampled to the third resolutions that are gradually changed from the first resolution to the second resolution.

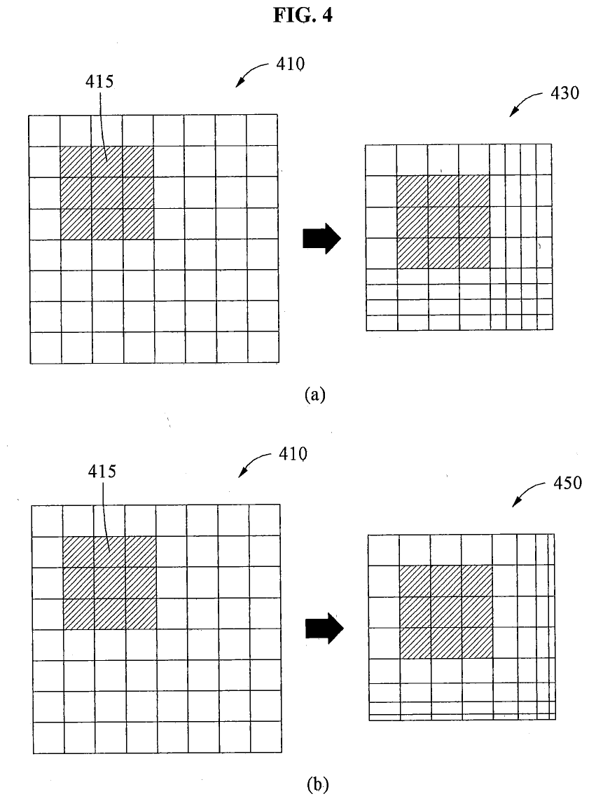

In operation 240, the image processing apparatus generates a second video by encoding the first video based on the axes of the grid. The image processing apparatus may divide the first video into a plurality of regions based on the axes of the grid. The image processing apparatus may generate a second video by sampling the information of the first video depending on the sizes of a plurality of regions. The image processing apparatus may generate the second video by encoding the first video with a preset codec. A method in which the image processing apparatus generates the second video will be described in detail with reference to FIG. 4.

In operation 250, the image processing apparatus outputs the second video and information about the axes of a grid. The image processing apparatus may visually encode information about the axes of the grid. The image processing apparatus may combine the visually encoded information and the second video and may output the combined result. For example, the image processing apparatus may perform color-encoding on the information of the axes of the grid in the second video to output the performed result. According to an embodiment, a method of encoding and outputting (or transmitting) the information about axes of a grid may be changed in various ways.

For example, the image processing apparatus may store the second video and the information about the axes of a grid in cloud storage.

FIG. 3 is a diagram illustrating a method of obtaining importance information according to an embodiment. Referring to FIG. 3, a screen 300 provided to a producer terminal via a monitoring application to set importance information is illustrated.

An original image (e.g., an original video stream) 310 may be provided in the screen 300. A producer may provide the image processing apparatus with the importance information indicating the importance of at least one region by assigning a mask to a critical region while the producer broadcasts the original video stream. For example, the producer may set a mask for at least one region, through an action, such as mouse click and/or dragging, for the original image 310. The monitoring application provided to the producer may provide the real-time monitoring, importance mask generation, and editing function of the original image 310 via a user interface 340.

For example, vertices 315 of a mesh for dividing the surface of a sphere-shaped model into a plurality of polygons may be displayed in the original image 310 together. At this time, the areas of the divided plurality of polygons may be the same.

For example, the producer may assign two masks 320 and 330 to the original image 310 via the user interface 340. Furthermore, the producer may set the importance of each of the regions corresponding to two masks 320 and 330, the playback time point of a frame including the two masks 320 and 330, the number of vertices included in each of the regions corresponding to the two masks 320 and 330, and/or the mask number corresponding to at least one region, via the user interface 340. The importance of each of the above-mentioned regions, the playback time point of a frame including regions, the number of vertices included in each of the regions, and/or the mask number corresponding to each of the regions may be provided to the image processing apparatus as the importance information.

FIG. 4 is a diagram illustrating a method of generating a second video according to an embodiment. Referring to FIG. 4 (a), according to an embodiment, a second video 430 generated based on the axis of the grid determined by the image processing apparatus for a critical region 415 of a first video 410 is illustrated.

The image processing apparatus may generate a grid for each image frame. For example, the image processing apparatus may calculate an area value according to the importance of the corresponding region in units of each row and each column of the grid, based on a preset target capacity of the second video 430. The image processing apparatus may determine the axes of the grid such that the resolution of the critical region 415 corresponding to the grid is maintained and the resolution of the remaining regions other than the critical region 415 is down-sampled.

In more detail, the image processing apparatus may determine the size of a column included in the grid and the size of a row included in the grid based on importance information such that the first resolution of a critical region (e.g., the first region 415) of the first video 410 is higher than the second resolution of another region.

For example, the image processing apparatus may determine the size of a column included in the grid and the size of a row included in the grid based on the importance information such that the first resolution of the critical region (e.g., the first region 415) of the first video 410 is maintained to be the same as the source resolution of the first video and the second resolution of the remaining regions (e.g., the second region) other than the first region 415 is down-sampled.

As such, in the second video 430, the resolution of the region corresponding to the first region 415 of the first video 410 may be maintained as the same first resolution as the source resolution of the first video; on the other hand, in the second video 430, the resolution of the region corresponding to the remaining regions (e.g., the second region) other than the first region 415 may be set to the second resolution lower than the first resolution.

As described above, the image processing apparatus may generate the second video 430 by performing warping on the first video 410 in real time based on the axis of the grid determined for the critical region 415.

Referring to FIG. 4 (b), according to an embodiment, a second video 450 generated based on the axis of the grid determined by the image processing apparatus for the critical region 415 of the first video 410 is illustrated.

The image processing apparatus may determine the size of a column included in the grid and the size of a row included in the grid based on the importance information such that the first resolution of the critical region (e.g., the first region 415) of the first video 410 is maintained to be the same as the source resolution of the first video 410 and the resolution of third regions adjacent to the first region 415 is down-sampled to the third resolutions, which are gradually changed from the first resolution to the second resolution. At this time, the third regions may be partial regions adjacent to the first region 415 in the above-described second region.

As such, in the second video 430, the resolution of the region corresponding to the first region 415 of the first video 410 may be maintained as the same first resolution as the source resolution of the first video; on the other hand, in the second video 430, the resolution of the third regions adjacent to the first region 415 may be smoothly lowered farther away from the region corresponding to the first region 415 of the first video 410.

The image processing apparatus may quickly and efficiently perform warping based on the information about the axes of the grid in each frame by moving the grid in the direction of a column or a row. In this way, for example, the image processing apparatus may reduce the optimization time, which is required to calculate a width (w) and a height (h) for each vertex during warping, from O(w*h) to O(w+h).

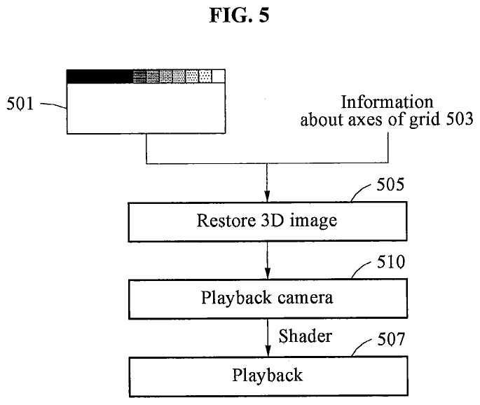

FIG. 5 is a diagram illustrating a method of playing an image according to an embodiment. Referring to FIG. 5, according to an embodiment, an apparatus (hereinafter, referred to as an “image playback apparatus”) for playing an image may receive an image 501 for a real-time live streaming service and information 503 about axes of a grid corresponding to the image 501. According to an embodiment, the information 503 about the axes of the grid is color-encoded and may be inserted into the image 501.

In operation 505, the image playback apparatus may restore a 3D image through texture mapping. The image playback apparatus may restore the 3D image by performing texture mapping on the image 501 based on the information 503 about the axes of the grid. For example, the 3D image may be 360-degree virtual reality streaming content.

In operation 507, the image playback apparatus may play the restored 3D image through a playback camera 510. For example, the image playback apparatus may play a 3D image through a shader. The image playback apparatus may render the 3D image such that the image corresponding to the current time point of the playback camera 510 is played. For example, when the 3D image is a 360-degree circular image, the image playback apparatus may identify which point's information needs to be read out in the viewing sphere including a plurality of polygons, in each of which each of vertices of the circular image uniformly divides the spherical surface, to play the 3D image.

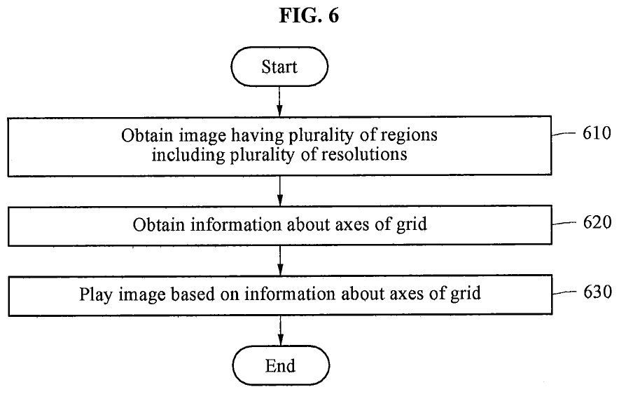

FIG. 6 is a flowchart illustrating a method of playing an image according to an embodiment. Referring to FIG. 6, in operation 610, an image playback apparatus according to an embodiment obtains an image having a plurality of regions including a plurality of resolutions. At this time, for example, the image may include information in which information about the axes of a grid corresponding to at least one region is visually encoded through various colors.

In operation 620, the image playback apparatus obtains information about the axes of the grid separating a plurality of regions. For example, the image playback apparatus may extract information about the axes of the visually encoded grid in the image. For example, the information about the axes of the grid may include the size of a column included in the grid and the size of a row included in the grid.

In operation 630, the image playback apparatus plays the image based on the information about the axes of the grid. According to an embodiment, the image playback apparatus may render a plurality of regions, based on the information about the axes of the grid. For example, the image playback apparatus may determine the texture of regions that uniformly divides a 360-degree image based on the information about the axes of the grid. The image playback apparatus may perform texture-mapping on a viewing sphere including a plurality of polygons that divide the spherical surface uniformly. At this time, because more pixels are included in the encoded image, the critical region is texture-mapped at a relatively high resolution. Because fewer pixels are included in the encoded image, the non-critical region is texture-mapped at a relatively low resolution. According to an embodiment, when playing a 360-degree image, the image playback apparatus may play an image of the region corresponding to the current time point in the viewing sphere.

FIG. 7 is a diagram illustrating a configuration of an image processing system according to an embodiment. Referring to FIG. 7, a configuration block diagram of a cloud-based content adaptive 360 VR live streaming system (hereinafter, referred to as a “live streaming system”) 700 according to an embodiment is illustrated.

The live streaming system 700 according to an embodiment may include the service server 710 providing a live streaming service. For example, when an image producer transmits a 360-degree image through the live stream protocol, the service server 710 may perform down-scaling and streaming services in real time while maximally preserving the resolution of the critical region in content through a cloud. The service server 710 may operate virtual server(s) (or virtual machine) as needed and may provide multi-channel live streaming service by increasing the number of virtual server(s) as desired.

The service server 710 may include a live stream collecting server 711, a remastering and encoding server 713, a network drive 715, and a streaming server 717.

For example, the live stream collecting server 711 may collect a broadcast (e.g., a source video) 701 transmitted through the live stream protocol. The live stream collecting server 711 may transmit the source video 701 to the remastering and encoding server 713 for image processing.

At this time, the producer terminal may monitor the source video 701 transmitted through the live stream protocol in advance and may transmit importance information indicating the importance of at least one region (e.g., a critical region) of the image frame to the remastering and encoding server 713. According to an embodiment, the live stream collecting server 711 may transmit the source video 701 to the producer terminal for live monitoring.

Even in a low-performance network environment, the service server 710 may provide a high-quality image streaming service through downscaling that maintains the original resolution of a critical region, based on the importance information. In more detail, the remastering and encoding server 713 may encode the source video 701, using the source video 701 and the importance information. The remastering and encoding server 713 may reduce the capacity of the image for the live streaming service by maximally maintaining the original resolution with respect to the critical region of each frame of the source video 701 set by a producer through live monitoring and by performing down-sampling the remaining regions other than the critical region.

The encoding output in the remastering and encoding server 713 may be encoded in different resolutions (e.g. 1080p, 720p, 480p, and the like) for resolution adaptive streaming and may be stored in the network drive 715. At this time, for example, the network drive 715 may be a drive on a network, which is used as if the hard disk of another computer connected over a network such as a LAN or the like is treated as a drive connected to the terminal of the network drive 715.

The encoding output stored in the network drive 715 may be provided to the streaming server 717 for a live streaming service.

The streaming server 717 may perform auto scaling on the encoding output. The streaming server 717 may include a plurality of virtual machines for load balancing. For example, the streaming server 717 may adjust the number of virtual machines depending on the number of viewers watching an image. Each virtual machine may operate as a server processing an HTTP request.

The image distributed through the streaming server 717 may be used to provide a live streaming service to the user by being delivered to a user terminal 750 through a content delivery network (CDN) 740.

The service server 710 may store the encoding output (a new image) in cloud storage 730. The service server 710 may provide the user with a video on demand (VOD) service by connecting the new image stored in the cloud storage 730 to an HTTP server (not illustrated) for the VOD service. The new image stored in the cloud storage 730 may be used to provide the VOD service to the user by being delivered to the user terminal 750 via the content delivery network CDN 740.

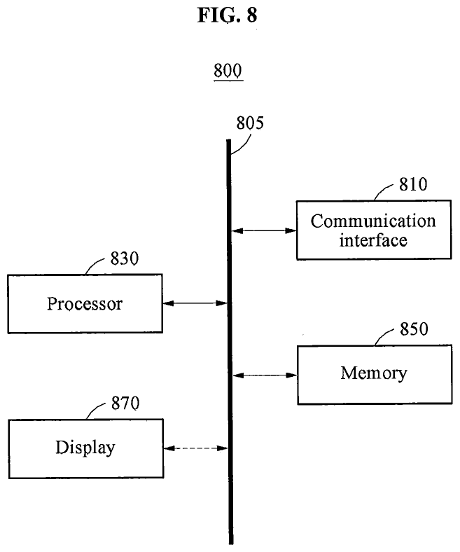

FIG. 8 is a block diagram of an apparatus for processing an image or an apparatus for playing an image according to an embodiment. Referring to FIG. 8, an apparatus 800 according to an embodiment includes a communication interface 810 and a processor 830. The apparatus 800 may further include a memory 850 and a display apparatus 870. The communication interface 810, the processor 830, the memory 850, and the display apparatus 870 may communicate with one another through a communication bus 805.

The communication interface 810 receives a first video including a plurality of frames. For example, the first video may be captured or photographed through a photographing apparatus (not illustrated), such as a camera or an image sensor, included in the apparatus 800 or may be an image photographed from the outside of the apparatus 800. Moreover, for example, the first video may be a 360-degree content image transmitted through a live stream protocol. The communication interface 810 outputs the second video and information about the axes of a grid. Alternatively, the communication interface 810 obtains an image having a plurality of regions including a plurality of resolutions.

The processor 830 obtains importance information indicating the importance of at least one region included in a plurality of frames. The processor 830 determines the axes of the grid for at least one region of the first video, based on importance information. The processor 830 generates a second video by encoding the first video based on the axes of the grid.

The memory 850 may store the second video generated by the processor 830 and/or information about the axes of the grid determined by the processor 830.

Alternatively, the processor 830 extracts information about the axes of the grid separating a plurality of regions. The processor 830 plays an image based on the information about the axes of the grid. For example, the processor 830 may play an image via the display 870.

In addition, the processor 830 may perform the at least one method described above with reference to FIGS. 1 to 7 or an algorithm corresponding to at least one method. The processor 830 may be a data processing apparatus implemented with hardware having a circuit having a physical structure for executing desired operations. For example, the desired operations may include codes or instructions included in a program. For example, the data processing apparatus implemented with hardware may include a microprocessor, a central processing unit, a processor core, a multi-core processor, a multiprocessor, an application-specific integrated circuit (ASIC), and a field programmable gate array (FPGA).

The processor 830 may execute the program and may control the apparatus 800. The program code executed by the processor 830 may be stored in the memory 850.

The memory 850 may store various pieces of information generated in the processing of the above-described processor 830. Besides, the memory 850 may store various data, programs, or the like. The memory 850 may include a volatile memory or a nonvolatile memory. The memory 850 may include a mass storage medium such as a hard disk to store various pieces of data.

The above-described embodiments may be implemented with hardware components, software components, and/or a combination of hardware components and software components. For example, the devices, methods, and components illustrated in the embodiments may be implemented in one or more general-use computers or special-purpose computers, such as a processor, a controller, a central processing unit (CPU), a graphics processing unit (GPU), an arithmetic logic unit (ALU), a digital signal processor, a microcomputer, a field programmable gate array (FPGA), a programmable logic unit (PLU), a microprocessor, an application specific integrated circuits (ASICS), or any device which may execute instructions and respond.

The methods according to the above-described embodiment may be implemented as program commands capable of being performed through various computer means and may be recorded in computer-readable media. The computer-readable medium may also include the program instructions, data files, data structures, or a combination thereof. The program instructions recorded in the media may be designed and configured specially for the embodiments or be known and available to those skilled in computer software. The computer-readable medium may include hardware devices, which are specially configured to store and execute program instructions, such as magnetic media (e.g., a hard disk, a floppy disk, or a magnetic tape), optical recording media (e.g., CD-ROM and DVD), magneto-optical media (e.g., a floptical disk), read only memories (ROMs), random access memories (RAMs), and flash memories. Examples of computer instructions include not only machine language codes created by a compiler, but also high-level language codes that are capable of being executed by a computer by using an interpreter or the like. The described hardware devices may be configured to act as one or more software modules to perform the operations of the above-described embodiments, or vice versa.

As described above, even though embodiments have been described with reference to restricted drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents. Therefore, other implements, other embodiments, and equivalents to claims are within the scope of the following claims.

1. A method of processing an image, the method comprising:
receiving a first video including a plurality of frames;
obtaining importance information indicating importance of at least one region included in the plurality of frames;
determining axes of a grid for at least one region of the first video, based on the importance information;
generating a second video by encoding the first video based on the axes of the grid; and
outputting the second video and information about the axes of the grid.

2. The method of claim 1, wherein the determining of the axes of the grid includes:
determining the axes of the grid such that a resolution of the at least one region is maintained and a resolution of remaining regions other than the at least one region is down-sampled, based on the importance information.

3. The method of claim 1, wherein the determining of the axes of the grid includes:
determining the axes of the grid based on a preset target capacity of an image, by setting at least one of the number of grids for at least one region included in the plurality of frames of the first video and a target resolution of the grid.

4. The method of claim 3, wherein the determining of the axes of the grid includes at least one of:
determining the axes of the grid by determining a source resolution of the first video as a first resolution of a first region corresponding to a target resolution of the grid;
determining the axes of the grid such that a resolution of a remaining second region other than the first region is down-sampled to a second resolution lower than the first resolution; and
determining the axes of the grid such that a resolution of third regions adjacent to the first region is down-sampled to third resolutions gradually changed from the first resolution to the second resolution.

5. The method of claim 4, wherein the second resolution is determined based on the preset target capacity of the image.

6. The method of claim 1, wherein the determining of the axes of the grid includes:
determining a size of a column included in the grid and a size of a row included in the grid.

7. The method of claim 6, wherein the determining of the size of the column and the size of the row includes:
increasing at least one of the size of the column and the size of the row for a corresponding region as importance of a region, which is indicated by the importance information, is higher than a preset criterion.

8. The method of claim 1, wherein the generating of the second video includes:
dividing the first video into a plurality of regions based on the axes of the grid; and
sampling information of the first video depending on sizes of the plurality of regions.

9. The method of claim 1, wherein the outputting includes:
visually encoding the information about the axes of the grid; and
combining and outputting the visually encoded information and the second video.

10. The method of claim 1, wherein the obtaining of the importance information includes at least one of:
receiving the importance information set in compliance with at least one region of each frame of the first video, from a producer terminal monitoring the first video; and
receiving the importance information determined in real time in compliance with the at least one region of each frame of the first video by a neural network trained in advance.

11. The method of claim 1, wherein the first video includes a 360-degree virtual reality streaming content.

12. The method of claim 1, further comprising:
storing the second video and the information about the axes of the grid, in cloud storage.

13. A method of playing an image, the method comprising:
obtaining an image having a plurality of regions including a plurality of resolutions;
obtaining information about axes of a grid separating the plurality of regions; and
playing the image based on the information about the axes of the grid.

14. The method of claim 13, wherein the information about the axes of the grid includes a size of a column included in the grid and a size of a row included in the grid.

15. The method of claim 13, further comprising: extracting the information about the axes of the grid corresponding to at least one region of the image, from the image.

16. The method of claim 13, wherein the playing of the image includes:
rendering the plurality of regions based on the image and information about the axes of the grid.

17. The method of claim 16, wherein the playing of the image further includes:
playing at least part of a region corresponding to a current time point of a playback camera among the rendered plurality of regions.

18. A non-transitory computer-readable recording medium having recorded thereon a program for executing the method of claim 1.

19. An apparatus for processing an image, the apparatus comprising
a communication interface configured to receive a first video including a plurality of frames; and
a processor, wherein the processor is configured to:
obtain importance information indicating importance of at least one region included in the plurality of frames;
determine axes of a grid for at least one region of the first video based on the importance information; and
encode the first video based on the axes of the grid to generate a second video, and
wherein the communication interface outputs the second video and information of the axes of the grid.
